(19) United States
(12) Patent Application Publication
(10) Pub. No.: US 2006/0047698 A1
(43) Pub. Date: Mar. 2, 2006

(54) Method and system for creating, tracking, casting and reporting on moving image projects

(75) Inventor: Susan Jean Fox, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Casting Workbook Services Inc., Vancouver (CA)

(21) Appl. No.: 11/143,475

(22) Filed: Jun. 3, 2005

Related U.S. Application Data
(60) Provisional application No. 60/576,311, filed on Jun. 3, 2004.
(60) Provisional application No. 60/666,583, filed on Mar. 31, 2005.

(51) Int. Cl. G06F 17/00

(52) U.S. Cl. 707/103 X

(57) ABSTRACT

The traditional method for tracking and reporting information on entertainment projects is inefficient, laborious, time consuming and costly. The invention provides a method of using the Internet to facilitate creating, tracking, casting and reporting on a plurality of entertainment projects by permitting multiple users each having varying levels of security to upload data to a relational database via a web site.

### Reference to Related Application

This application claims priority from U.S. provisional applications No. 60/576,311 filed Jun. 3, 2004, and No. 60/666,583 filed Mar. 31, 2005 which are pending.

### TECHNICAL FIELD

The invention relates to the entertainment industry and more particularly to the creation, tracking, casting and reporting on moving image (film, television and video) projects in various industry stages.

### BACKGROUND

In the entertainment industry, particularly film and television, traditionally Entertainment Professionals, such as Agents, Talent, Writers, Casting Directors, Producers, Networks and Studios etc. (“Professionals”), track Projects (films, television shows, commercials, videos and the like) and Talent (actors, dancers, models, musicians, writers, directors and the like) in order to predict when Open Assignments become available. “Open Assignment” is an Entertainment Industry term that is used when there is an opening in one of the key roles on a production, such as director, actor and/or writer. By tracking this information, predictions can be made as to when Talent should be submitted for a Project that would result in the greatest likelihood of success.

Some Professionals look for relationships between Project and Talent. This information helps them make decisions regarding future and ongoing Projects. Having the right kind of information helps a Producer or Studio make an informed decision when picking a premiere date for a film or TV show. The same relationships in the data help some Professionals, such as talent agents who represent Talent (“Agents”) see trends in the types of Projects that Studios and Producers are currently developing. With this information they can market their Talent more effectively and with greater success. Furthermore, having this kind of information at their disposal is extremely valuable in creating and pitching Talent Packages (e.g. Director/Writer/Actor combinations, often used to get a production “Greenlight”. Greenlight is an industry term for giving approval to send a Project in development).

Currently, these relationships on Projects and Talent are gathered in several ways: through the trades (e.g. Variety Magazine); word-of-mouth; or using a third party service such as the Internet Movie Database (IMDB) or Baseline's Film Tracker™. Historically, Professionals take information that they have gathered and create internal databases and/or lists using Microsoft Word™ or Microsoft Excel™. As a result, the information is often not relational and trends can be missed. In addition, data may be kept in too many sources to be of value, particularly when they are looking for information quickly. The information also is not shareable and there is no easy workflow in gathering the data. Historically, the Professional would have gathered the elements, sent them by a variety of means and hoped that they were received and opened. There is no current cohesive tracking system except when sent by courier, and even then packages are shown as received, but there is no way to know if they were opened by the recipient. Professionals receiving the materials are inundated with the Talent's elements and often become overwhelmed as the materials have no intrinsic organizational management system. There is no easy and efficient way to share the data. For example, audition sessions are taped and copies are then made and sent by traditional couriers from all over the world, hours, and sometimes days, after the audition has occurred. Because the materials must be copied in order to be shared, there is a considerable cost involved in the duplication, conversion and shipping methods currently used.

The traditional way of tracking and reporting moving image information is often extraneous to the everyday workflow; does not have the value and meaning that it could have; and it often becomes out of date quickly because it takes the effort of the Professional to update the information in ways that are sometimes outside their everyday workflow; it is costly for the Professional to share data not only in monetary value, but also in the time it takes to have the materials delivered. There is therefore a need for a method of creating, tracking, casting and reporting on moving image projects in various industry stages which is more effective and efficient.

### SUMMARY OF INVENTION

The invention provides a method of using the Internet to permit a plurality of users each having a computer with a web browser to create, track, cast and report on any one of a plurality of entertainment projects each having a unique title, the method comprising i) providing a web site maintained by a server accessible over the Internet to the plurality of users and communicating with a relational database searchable and retrievable by a search engine; ii) a first user accessing said web site and creating a first project file for a first one of the entertainment projects by associating a unique identifier with said unique title; iii) the user assigning a security level to the first project file wherein the security level is selected from the group consisting of private, shareable or public; iv) the first user and others of said plurality of users periodically uploading data for storage on the database in association with the first project file depending on the selected level of security; v) repeating steps i) through iv) to thereby produce by additonal creating users a plurality of project files each having data associated therewith; and vi) the first user, the additional creating users and/or others of the plurality of users accessing the web site and searching and retrieving certain of the data stored in the database in association with the plurality of project files depending on the selected level of security.

### BRIEF DESCRIPTION OF DRAWINGS

In drawings which disclose a preferred embodiment of the invention:

FIG. 1 is a Flow Chart illustrating the overall flow of the system.

FIG. 2 is a Domain Model chart illustrating the main objects of this invention.

FIG. 3 is a Flow Chart illustrating the creation of a project.

FIG. 4 is a Flow Chart illustrating the management of categories.

FIG. 5 is a Flow Chart illustrating the managing of Roles in a project and the talent considered for those roles.

FIG. 6 is a Flow Chart illustrating the adding of Talent to a project

FIG. 7 is a Flow Chart illustrating the Archiving of Projects

FIG. 8 is a Flow Chart illustrating the Reporting feature of the invention.

FIG. 9 is a Flow Chart illustrating the Contact Management feature of the invention.

FIG. 10 is a Flow Chart illustrating the overview of uploading materials to a Studio project.

FIG. 10a is a Flow Chart illustrating the workflow for uploading materials (e.g. videos)

FIG. 10b is a Flow Chart illustrating the management of materials for the Outside Casting Director or Agent

FIG. 10c is a Flow Chart illustrating the management of materials for the Casting Director

FIG. 11 is a Flow Chart illustrating the creation of a ClipBook

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention provides an Internet Website System for the creation, tracking, casting and reporting on moving image projects in various industry stages: from the conceptual idea, development, pre-production (casting), production and post production, (“Project”) and as it relates to uploading, disseminating, sharing, researching, reporting, attaching and pitching materials including audio, video, photographs, scripts, documents, dates and information (“Elements”) that are associated with Projects, companies as well as actors, models and other talent, writers, directors, producers, crew, etc, (“Talent”) to those Projects.

The Invention provides a method for Agents, Writers, Actors and other Talent, Casting Directors, Producers, Production Companies, Distribution Companies, Networks, Studios as well as various production professionals (“Users”) to: create Projects and Talent records; upload and attach Talent, Elements and Events, electronically market that Talent, (in some cases, themselves); create relationships in the data as well as add to calendar(s) based upon User permission, provide reporting and meaning; and share Project Elements and information with other professionals efficiently. The Invention fits into and leverages the workflow of its Users. Rather than employ people to gather the information, that is sometimes acquired long after a project has been completed and released to the general public, Users in their everyday workflow of managing Projects and Talent contribute to a global shareable database.

The information gathered is current and has more meaning to a User than information that is dated. Furthermore, this method of gathering information means the information is more accurate than the information gathered by one of the traditional methods. Personalized Information or information gathered by one of the traditional methods can also be added to the Project, Talent, Element or Event to enhance the information.

The Invention improves on existing systems by acquiring the bulk of data and information as a result of specialized industry workflow rather than manual input. This system combines digital content management and digital delivery systems allowing the upload, management and sharing of Elements and Events, that can be tracked and managed on calendars and reports. In addition, the entire Invention allows for selective sharing of this information within multiple User groups inside and outside of their current workflow.

The Invention works with the systems disclosed in U.S. patent application Ser. Nos. 11/101539 filed Apr. 8, 2005, Ser. No. 11/102730 filed Apr. 11, 2005, and U.S. provisional application 60/599,874 filed Aug. 10, 2004, 60/599,885 filed Aug. 10, 2004, 60/631,432 filed Nov. 30, 2004 and 60/631,507 filed Nov. 30, 2004, all of which are incorporated herein by reference, and which disclose Talent Management System; Booking System; Submission System; Inclusion of 3^{rd} Party Portal Information; Contact Management System; Production Management and Scheduling/Calendaring Systems; ePitch™; ePackage™; Now Appearing; and Newsletters. These other systems act as feeders by adding information into the Invention to further enhance the quantity and breadth of information being tracked, and the reports and workflow provided by the Invention. The 3^{rd} Party Portal Information System, provides a convenient way to add and automate information coming from other information systems, as long as they can communicate with the 3^{rd} Party Portal Information System via its API (“Application Programming Interface”). The core data of the Invention is Project information and Elements. The data is stored in a relational database that uses extensive indexing to aid in the searching and reporting of the data.

The Invention also has security rules that allow for sharing of Project information and its Elements. Users can choose which parts of the Project information can be shared, and which parts remain private. The Elements that are attached to the Project, for example, audition and session videos, can be shared with one or more Users on an individual audition basis or by groups of auditions (called sessions). The Invention provides several layers of security: Private, Shareable and Public. Private information is available only to the User who created it (“Creator”), and is hidden from anyone else using the Invention. Shareable information has two levels: shareable to a select group of Users designated by the Creator of the information or Shareable to an entire Community of authorized users, in other words any authenticated user who has access to the invention either though direct query or through an Authenticated Atom service (RSS/XML Data Feed). The final level is Public. Public means that the information will be available publicly through a public website or through a publicly accessible RSS Feed that will allow anonymous users to peruse the information. A User's roles and rights are determined on a Project by Project basis. A User can be given Read Access to Shareable information. Contributor Access allows the User the ability to add to the data and make changes. Delete permissions are turned on or off explicitly for Contributors by the Admins of the Project. Admin Access which is automatically given to the Creator allows User to do whatever they wish to the project: add, modify and delete information. Much like the file system on a computer, the security rights are inherited from the Project's Security Level. So when information or materials are added, Users of the system maintain their Security rights.

The User or several different Users enter information about a Project. For example, if a Project became Shareable and its subsequent information was shareable then as more information becomes available to the project, all Users who were sharing that project would see the information and update it as required, therefore making the data more current and accurate. The information that a User can enter about a Project is limitless and can be varied between different Projects. There will be a default set of information that is consistent across all Projects, for example, Producers, Director, Actor, Writer, but the User can add more categories of information. For example, a User could add the Unit Production Manager if they find that information relevant.

The Invention allows for the uploading of project related materials. Scripts, documents, videos and photographs are all project related materials. Anything related to the project that is or can be digitized can be uploaded to the Project's library. The Project's library is a container for the elements and can be organized in relation to the material type, and it's place in the Project's timeline (e.g. Casting, which occurs early in the pre-production stage). The Invention allows for a Project to be tracked from the beginning to end. The Invention allows for searching and viewing of materials of the Project as it goes through the stages of Development, Pre-Production, Production and Post Production. Not only can Users search for Talent associated with a project, but also the Talent's information, Session and Audition Tapes, documents related to the project such as a script, and Events such as Open Assignment postings, or other Events from other feeder systems. Because the Invention goes across all stages, the Invention works with all Users related to the Project. Users only involved in the development stage will be able to use the Invention, just like the Users in the Post Production stage.

The Invention also increases productivity because of the ease in which data is shared and stored. The Users do not have to wait a day to see an Audition that happened far away. They can see it in hours. Furthermore, because the Project's information is digitized, it can be archived and stored for historical reference. This allows for cross-Project relationships that previously were rarely identified. As more Users use the Invention the database of Projects, their materials grow exponentially. The reports become richer and more meaningful. The information becomes timelier and relationships become more clearly exposed. The Invention provides a repository for a Project so that the information is easy to access and easy to distribute.

The Invention also provides methods for Users to produce physical reports. One such report is Clipbooks. Traditionally, Clipbooks are physical notebooks that have a headshot and resume of Talent that are considered for roles in a Project. When the information is digitized there still needs to be a way for Users to create these physical notebooks for non-Users of the system. Clipbooks provides such a means. The Invention provides reports on material usage. Users in the Development Phase will be able to have an easy-to-access report that displays how often a particular photo was used, or a video clip was sent to someone, either electronically or physically. They can also view usage graphics of statistical usage to gauge the effectiveness of those materials. The Invention will also allow Users to pull up historical information on a person or project for marketing and strategic planning. Using this information the User is able to create marketable Talent Packages. A typical Package is a Director and Writer. The pair is usually pitched together for a project, and it is expected that both will be hired on the Project. A Package can also include one or more Actors, usually a big-name actor with a high box office draw. When the casting process begins, the Project in the database is then used in the Submission System and Talent Management System. The information that would be added would include potential cast lists and also an historical reference of who was suggested, considered and eventually was offered the role, along with information about that Talent.

As the Casting Process continues, the Casting Director can schedule audition times using the Audition Scheduling as disclosed in U.S. patent application Ser. No. 11/102730. They can then digitally shoot and upload the videos to a Server, where they can be added to the Project Library and other Users can be given rights to review the videos and make notes. As the project moves from the Development Phase to the Production Phase, the Project then has different information attached to it, for example, Audition Videos and Dailies. Different types of Users would become involved and thus the project and more information would be added. Also during the Production Phase, principal filming will begin. Each day a User can upload dailies (snippets of material shot on film) to the Project, plus they can upload Production Reports, Call Sheets, and other documents for dissemination and historical reference. These documents are the Project's legal documents, but this information is valuable to Executives and Professionals who may be located far from the actual shooting location. Having historical reference is also valuable if the Project is audited. In the Post Production Phase, box office and distribution information is added, as well as below-the-line credits, such as grips, wardrobe and other crew members. The Invention allows for the searching of information, both public and private, based upon the User's security level for that project. Anything attached to that project in all of the phases will be searchable. All Users will be able to search, with the results based on the User's security level for specific Projects. If a User does not have rights to a Project and/or materials in the Project then the Project or references to the material in the Project would never be presented to the User. Searches can be made or organized around any information type within the system, such as Projects, Talent, Users, Elements, Events, etc. For example, Project searches, would provide results contained in one or more Projects; Talent searches would provide results of Talent found across many Projects; User searches would show results from any Project, Talent, Event or Element created, modified or seen by a particular User; Element searches would provide uses of Elements in Projects, Talent or in any of the many Event types such as ePitches; Event searches would show results from any Event type found in Projects or including certain Talent. These Searches can also be saved by Users, for future re-use, copying or modification, providing a way to ensure future consistency in searching and reporting.

The Invention allows a User to create a variety of reports using both private and public data to highlight the specific relationships in the data that will prove useful to the User, for example, what Project a particular director is working on, a list of all the open assignments and who has been attached, depending on their level of security on the project itself. The Invention also includes a reporting engine that allows a User to create customized reports using the information that is available to them based on the security level of the project. The User will also be able to select from a set of “canned” reports that will highlight relationships in the data. Similar to the search engine, the reporting engine will be used to highlight relationships in the data rather than just locating specific information. The Invention allows the User to be able to print, save to Microsoft Excel™ and ePitch™ reports to individuals.

The Invention interfaces with existing systems such as ePitch™ and ePackage™. These systems allow the user to send specific elements (e.g. videos, photos, documents) and information about that Project or Talent to other individuals inside and outside the system. The Invention interfaces with the Contact Management System, which allows a User to find out contact information such as email, phone number and assistant information on key personnel of a project. The Invention also creates Reports which support Users' daily workflow and provide new workflow opportunities. Calendar reports provide various calendar views of information and events from the Invention giving familiar calendar access to production events historical, current and future, pulled from information in the Invention. Any standard calendar types of events and information can also be added by the User, meaning the Invention provides the User with a unified calendar/planner tying together a User's personal planning with the vast source of industry events, and information relating to the Projects, Talent, Elements or Events that they are working on or tracking. Thus the Invention not only feeds itself from the daily workflow of its Users, but also enhances their daily workflow for them in return.

For example, an Agent using the Invention would be able to ePitch their Talent and track the materials electronically thus combining stored electronic Elements with relevant Project information in a website environment facilitating sharing. The Professional using a variety of delivery methods that are compatible with the Invention will be able to have a record of recipients for the Element(s), when they were received, and in some cases, if the recipient actually reviewed the Element(s). Delivery methods that are compatible with the Invention include ePitch for online electronic delivery and ePackage for sending materials to different cities within the same day.

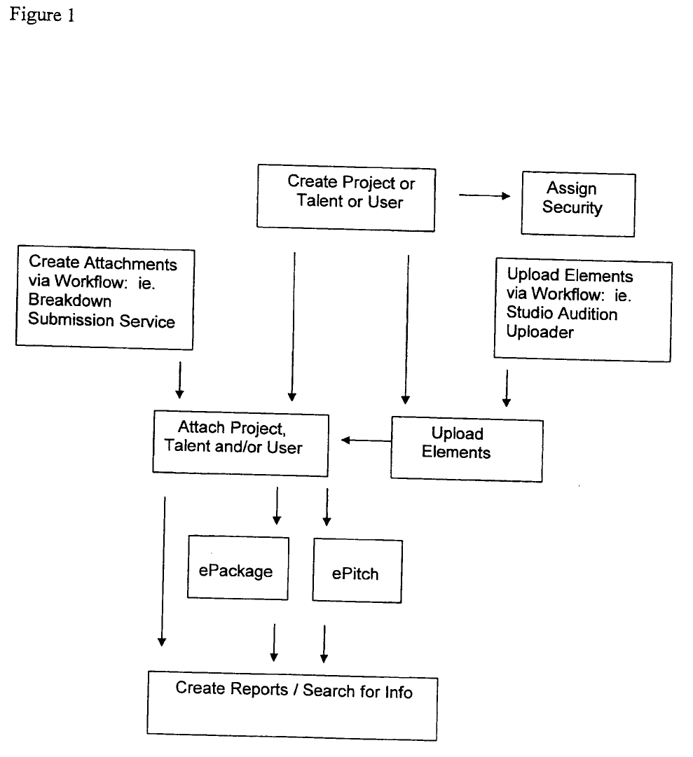

With reference to FIG. 1, a User has two options for adding Projects to their database, they can pick from a Shareable/Public list or they can create a Project using the Project Setup module. If the User creates a New Project, the Invention generates, associated with a title, a new Project ID in the Database and assigns it to that Project. The User or Creator of the Project becomes the Admin and they can assign other Users access to the Project and its materials, as well as roles for the Project. If the User imports a Project, the Invention creates a clone of the Project, giving it a clone Project ID. The Clone will always have the parent project ID or source Project to link back to. The User importing the Project becomes the Project Admin of the cloned Project. The clone automatically becomes Private so any information that is changed will not become public or shareable.

When the Clone Project's security level is the same as the parent, the information from the clone is merged back into the parent or source Project. The Administrator of the Clone can also, if they so desire, retain a different security level from the source, but still update the source parent by allowing some of the information to be merged back into the parent or source. The creating User can then enter and define the initial categories or metadata for that Project. The User can also use a predefined template that has the shell of the Project's information categories defined so all the User has to do is enter the information. An example of a template would be a set of pre-defined metadata for a Project, such as Director, Producer, Writer, Talent, etc. The User can assign a security level for the Project: Private, Shareable and Public. Private is the default level for all newly created or cloned Projects. If the User selects Shareable, they would then further define who it is shared with and what part of the Project information is shared, plus the security roles those assigned Users have. If a Project is Private then only one person can work and see the data—the person creating the Project. If the User wants to have their assistant work with the data for them, the Project has to be shareable, but it is shared with only one person. The User(s) then begin to add, modify, and correct information about a Project, as it changes in real time in the course of their daily workflow. For example, if the User's role is working with a Project that is in the development phase, they would then attach Talent. If the User is an Agent they would then attach people from their Roster. Users who are Producers and Casting Directors would be able to attach anyone from the Casting Workbook Talent Database. By attaching Talent to a Project, it creates an association and historical reference so as the Talent goes through the audition process a report of how that talent did can be seen by the Agent.

In addition, a Casting Director hired for the Project can assign other users access to the their information in the form of Favorites. Favorites are lists of Project, People and/or Companies, plus materials related to same, that can be shared. Favorite Lists have different security rules so they are independent of a Project. For example, a Casting Director can create a list of Favorite Talent considered for a role and share that list with someone who has not been given rights to the complete list. These Favorite Lists provide an easy way for Users to share information or pieces of information with other Users quickly, who don't have access to the Invention or they don't need access to all the information to a Project.

If a Casting Director or Producer is seeking submissions for open roles, they make the Project and relevant information Shareable to Agents, so they can receive Talent submissions. By having the submission process automated and online, there is a cost savings to the Casting Director, as well as the Production Company, and information is easily accessed by Producers and Executives. It also provides historical data for the Project and associated Talent, Elements, etc. Furthermore, Users with appropriate access can view reports and run searches during any part of this process to see how things are progressing and review materials. To search for information, Users enter Key Words into a search form. The results are determined by the security level of the User. For example, the results include information that is Public, Shareable to the user, and in the User's own private database of Projects. If a User's security is only to view public information, then the search results will only contain public information. The User will see only the information they have access to.

The search engine will search on the metadata of the Project, so for example if someone were to search for Steven Spielberg, then all Projects where Steven Spielberg's name is mentioned will be returned, provided the user searching has access to that information. If the User doesn't have access, then the information will not be returned. A User is able to save searches and rerun them later for updated results. A User is able to create a watch on Projects, Talent and Companies, so for example, if Project information changes, they will be made aware through either a list online or through an email or other alert. The User is able to interface with the ePitch™ or the ePackage™ systems so they will be able to market the people and Project. Using the ePitch™ system they will be able to send select information about a Project and the Talent attached to the Project anywhere in the world electronically or online. By using the ePackage™ system they will be able to send a physical copy of the same material in select cities. Both these systems interface with this Invention and allow the User to share and distribute information securely to people who are not members of the present system. The Invention interfaces with a Contact Management system which allows the User to create, manage and share a private contact database. The User uses the reporting engine to create customized reports. The user selects what information they wish to see on the report and save it to a report template. The information is generated and displayed to the User who can then save the report as a PDF, HTML file or even as a Microsoft Excelt™ Spreadsheet. The finished report can also be used with ePitch™ so it can be securely sent electronically. The User can select from a set of canned reports, which have been defined by industry professionals that are available to anyone who is authenticated. These reports can be run, saved, sent and tracked electronically using the ePitch™ system.

The public or anonymous user, working with the public database will not have access to the reporting system, but they will have access to the robust search engine to find and locate information. The public or anonymous user will be able to save searches, but they will not have access to the other systems such as ePitch™. Users can also upload materials (e.g. Videos, Documents, Photos) to the Project. Like the metadata and talent, the materials are searchable for easy reference. Used with another system, Dynamic Portfolios, the User can create custom presentations of the materials to be used with ePitch™ or ePackage™. Casting Directors are employed by Producers to handle the casting of the roles. The Invention provides a method for them to manage Audition information, upload audition or session videos and share those videos with others in the Project. The workflow a Casting Director uses to manage the Session Audition Videos, including the workflow to upload audition materials, is outlined below.

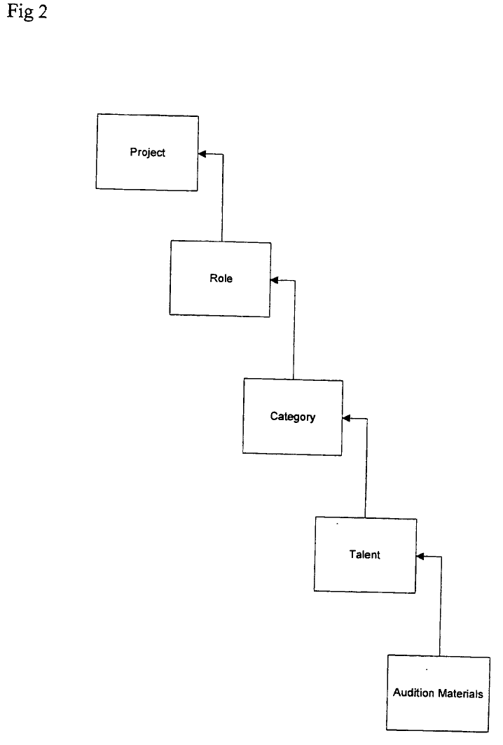

With reference to FIG. 2, the Domain Model shows the different items of a Project and how they relate to each other. This model also gives an overview of how the information is stored and displayed. A Project can have an unlimited number of roles, with unlimited number of categories, that have an unlimited number of Talent. The Categories are used for organizing the Talent as they are being considered for the roles or jobs, before and during the pre-production process.

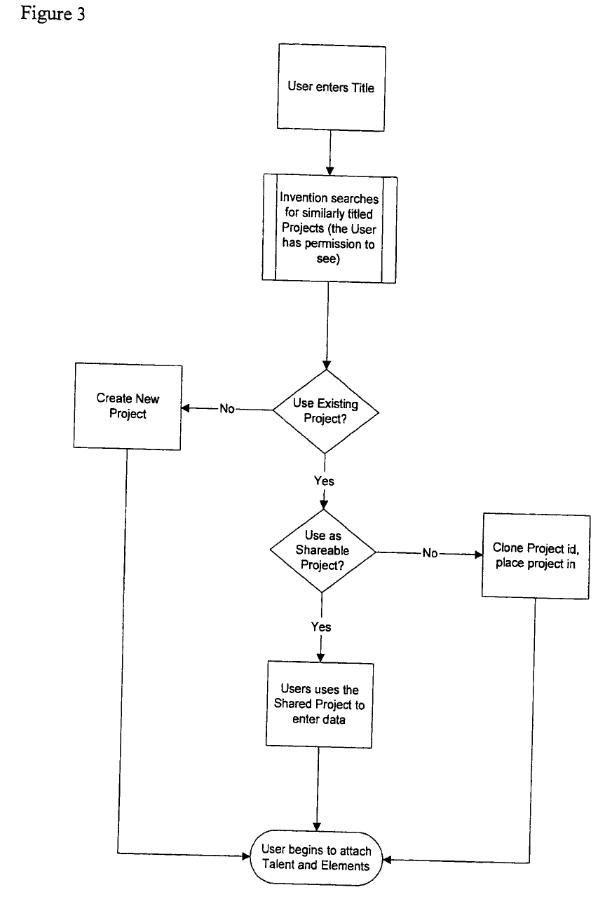

With reference to FIG. 3, a User can create a new Project. The User can use a Project that has already been created, that they have access to, or they create a new Project. To create a new Project the User enters the Title of the project, which is the only required field. The Invention will search for all projects, the user has access to, that match, or closely match the title that was entered. The Invention will ask the User if they wish to use an existing Project or create a new one. The benefit to the User of using an existing Project, is it will provide more data than would normally have to be manually entered, and as a benefit to others, the information the User will be entering will enhance the value of that Project. If they use an existing Project, they can either use it as a Shareable project, or they can keep it private in their own personal database.

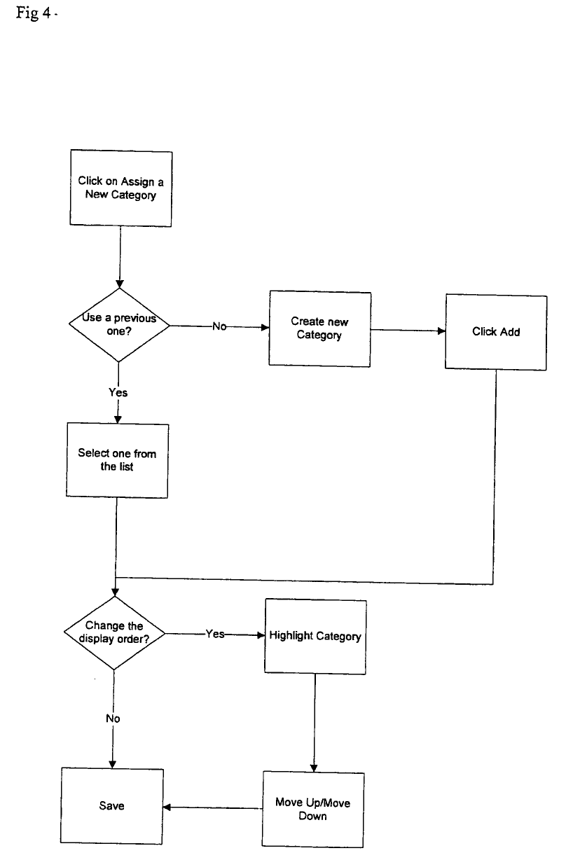

With reference to FIG. 4, a Casting Director can add, remove and define the order of the categories in regards to each role. They can add new categories at any time during the workflow. A Category can be anything, for example, “Seen in New York”. To add a new category or manage existing categories the Casting Director clicks on “Assign a New Category”. A window will open and they will be presented with the Category Manager. The Casting Director can add a new category by selecting from a list of previously used Categories for all Projects, or they can enter in a new category. After selecting a category they can reorder the categories to set the display on the worksheet pages.

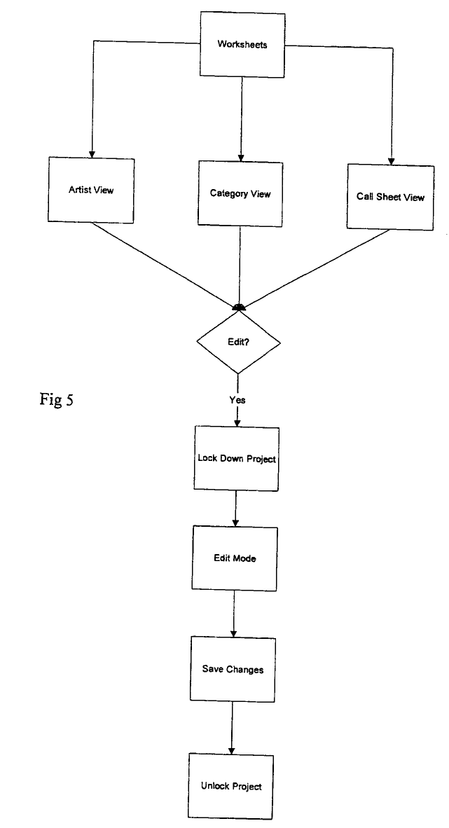

With reference to FIG. 5 which gives an overview of the “worksheets”. Worksheets are different views that allow the Casting Director (or Producer) an efficient method for managing the Roles. They have the Artist View which displays all the Talent being considered for the role. Presented with the Talent are notes made by the Casting Director (e.g. availability, interest, etc) and the category they are currently assigned. By selecting “Edit” the presentation layer changes from a read only view to an editable view where the Casting Director can edit the notes, remove the Talent or “Switch” them from one category to another. After selecting Update the view changes back to read only. While the Casting Director is editing the Project, no other person can edit the Project, thereby preventing data from being overwritten. The Casting Director can also assign other Users permission and grant contributor permissions so they can also update the information on an as-needed basis. The Category View of the worksheet presents the Roles, the categories and the Talent being considered. Again, the Casting Director clicks on “edit” and the view changes from a read-only view to an edit view, locking out anyone else who wishes to make updates. The final view is a Call Sheet view which lists all Talent considered for the Project, regardless of role or category, information on their Representation and the notes from the previous worksheets, as well as an “Avail” option which informs the Casting Director if they are available to play the role, should they be chosen. The Casting Director can show all Actors or select a few and limit the view to those chosen few. Like the previous worksheets, the Casting Director will be presented with a read-only view, and if they click “edit” and if the Project is available for editing the worksheet will change to an editable one.

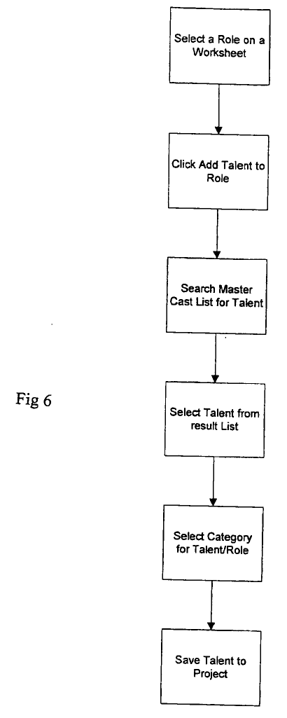

With reference to FIG. 6, the Casting Director can add Talent to Roles in a Project. The Casting Director will select a Role from a Project Worksheet, then next to each role name, the Casting Director selects ‘Add Talent to Role’. A window will open the Casting Director can add up to an unlimited number of Talent. They enter in as much of the Talent's first and/or last name they like, then click Search Master Cast List. The Invention will display a list of results, then they will then be able to select the talent that match the name which was entered. If that talent does exist in their Master Cast List, they can add the Talent to the Master Cast List. After choosing the Talent, they select the category the Talent belongs to. They also have the option to select a category and by clicking the “Set for All” button, set the same category for all the selected Talent.

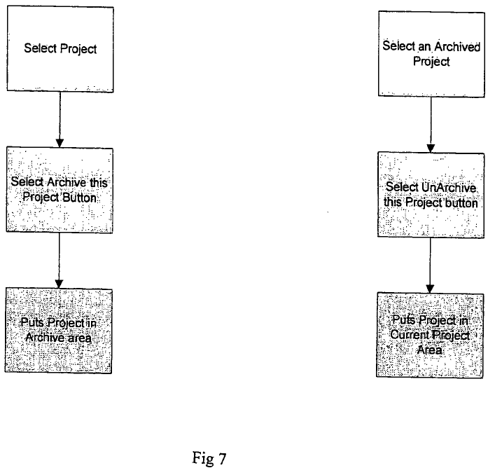

With reference to FIG. 7, the Casting Director can at any time “Archive” a Project to keep their working Projects easily manageable. The Casting Director clicks on the “Archive This Project” which flags the Project that it now belongs to the archive. The Archive Project has all the same features as a current Project, and can be managed the same way. The Casting Director can at any time unarchive a Project much the same way. They go to the archive, click un-archive and the Project will now display in the current Project's list.

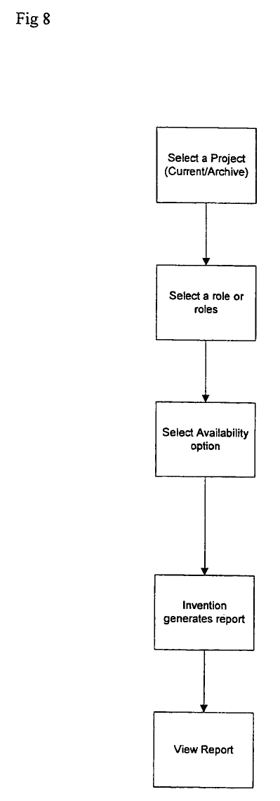

With reference to FIG. 8, the Casting Director can at any time create a report on a specific Project and if they so desire on a specific role or roles. The invention will generate a report based on the criteria that will display the Project Title, Role, Category, Talent name, Rep information, Notes that may have been entered and if they are available or not.

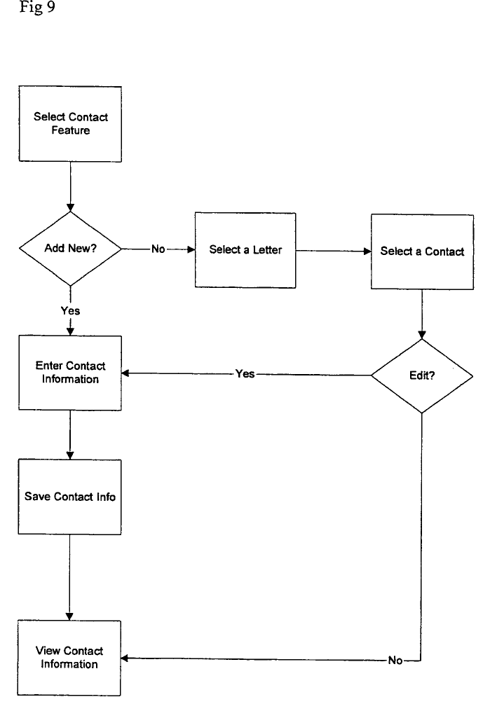

With reference to FIG. 9, the Casting Director can manage personnel attached to Projects and keep a database record of their contact information, personal information and personal notes regarding the individual. A Person added to a Project is automatically added to the Contact Feature for easy management. The information added to the Contact Feature is also used in the print view of the Project Contact page that a Casting Director can run at anytime during the workflow. The “print” view allows the Casting Director the ability to print the Executive Contact Information (e.g. Phone numbers, email) for that Project. The Casting Director clicks on the Contact Feature of the invention. They can enter in a new contact, selecting their job titles and division, as well as much of the contact information they have available regarding that individual. They can also do a quick look up of contacts and edit the information.

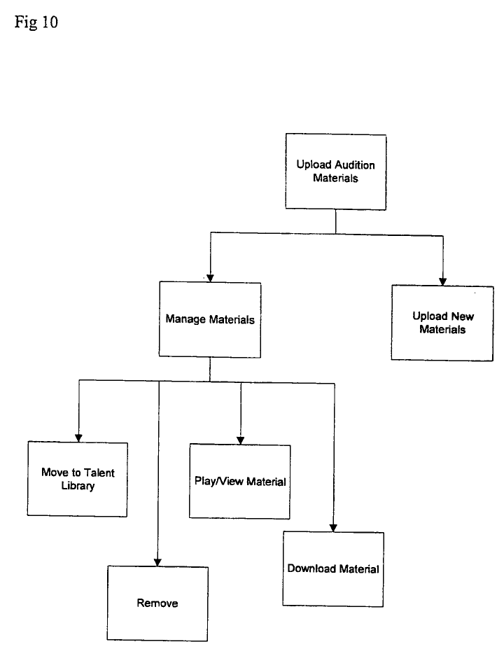

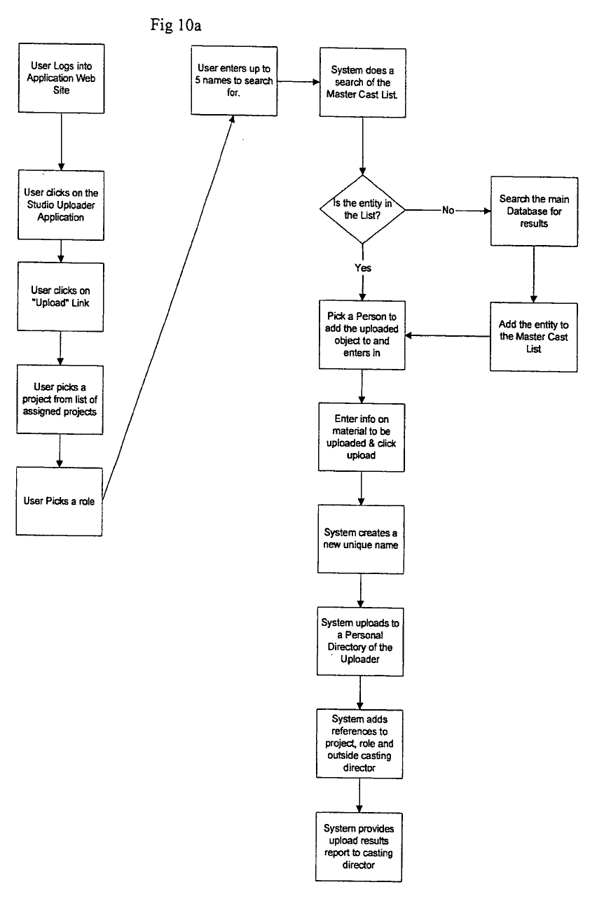

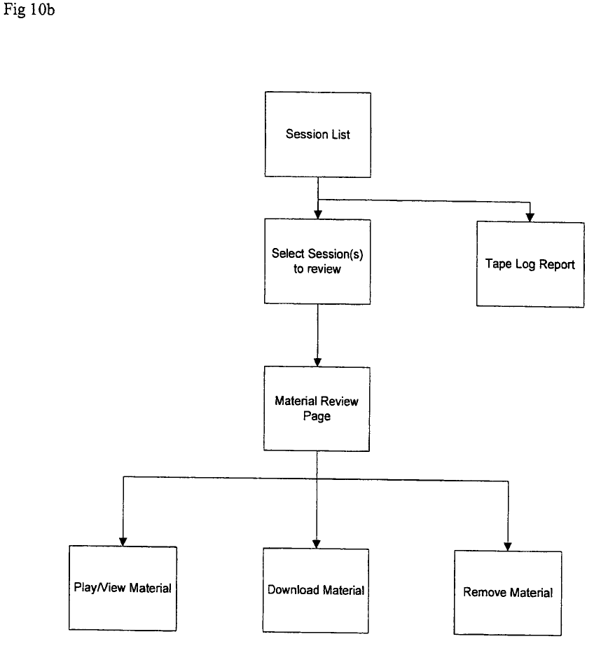

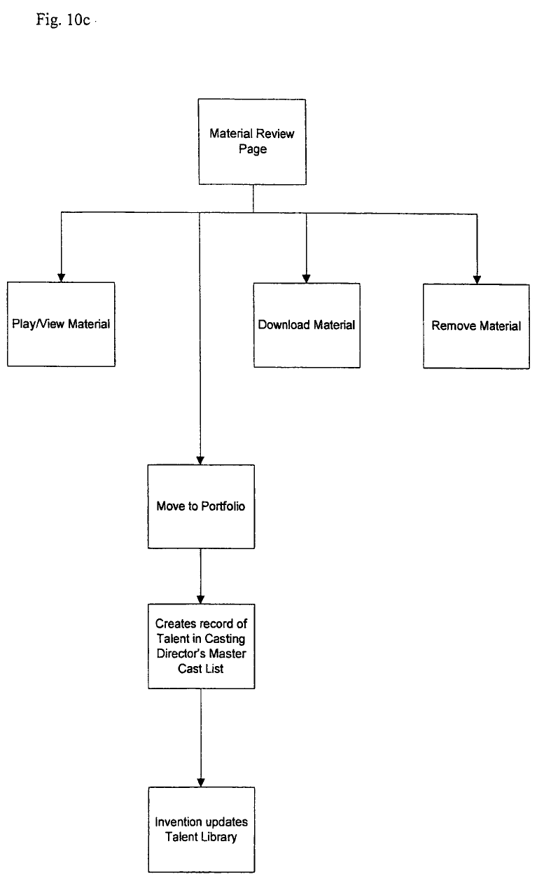

With reference to FIG. 10, the Casting Director can assign permission for outside Casting Directors and Agents to allow them the ability to upload auditions (e.g. digitized video) for Talent under consideration for a Project. The Outside Casting Director or Agent, will log into a portal website and select the upload feature. They will be presented with a review of all materials they have previously uploaded. They can also manage any previously uploaded materials that belong to them as the uploader. The Casting Director can manage all the materials for a Project as well as move the materials to the Talent's library in the Master Cast List. With reference to FIGS. 10a, 10b and 10c, the Outside Casting Director or Agent will select the ‘Upload Material’ link. They will select a Project, and a Role. The Casting Director can assign more than one Outside Casting Director or Agent to a Project for uploading, or they can not allow anyone outside the Studio to upload Audition materials to the Project. They search for Talent who auditioned for that role. The invention will search the Master Cast List and present back the Talent found. If that Talent isn't there, the Outside Casting Director or Agent can add the Talent to the Master Cast List. They select the talent and then they enter in a title, length, and notes for the materials that will communicate to the Casting Director what the material is about. They will select the type of media (Video, Audio, and Photo of the Actor taken at the time of the audition (“Polaroid”)) and then they will select the browse button to locate the media on their hard drives. After selecting the materials and entering in the pertinent data, they select “Upload” and the invention will upload the materials, assigning the materials a new name and recording the upload in the database.

The Invention will present to the Outside Casting Director or Agent a list of materials uploaded and if they were successful. The Invention will also add the Talent to the selected Project and Role and add them to a category called “Seen by <Casting Director Name>” for easy reference. The Casting Director can log into the Invention, click on the “Session List” and review a list of uploads, who uploaded them, the type of upload and the option to play/view or download the material. The Session List also have a report called Tape Log. The Tape Log provides an easy read document with the Casting Director information, Session Information, a Thumbnail of the Actor, their name, agent and any notes made by the Casting Director during the session. The Casting Director can select the Move option and have the invention place a copy of the uploaded material into the Talent's Library (“Video or Audio Vault”). They can also remove it from their upload list. Or they can download it and edit the material and then upload it directly to the Talent's Library. The Casting Director can also select videos from the Video or Audio Vault and attach them to a Project/Role in a similar workflow as uploading. The Casting Director can also filter the list by Project, and then by the Uploading Casting Director or Agent. The Outside Casting Director or Agent can also review a list of their uploads and manage them. They can remove them or they can play and download them again, should they need to. Only when the Outside Casting Director or Agent have both opted to remove the file will the server clean up the files and move them to the trash. After a predetermined time in the trash, for example, two weeks, the server will then permanently remove the files from the server. Until the files are permanently removed from the server, they are recoverable and can be placed back on the review pages through a set of admin tools.

When the Casting Director has a large number of uploads, they can use an FTP (File Transfer Protocol) Client to upload the videos to an FTP Server. The Casting Director clicks “Upload by FTP”. They select the file or files that have been put on the FTP Server in their secure area. Then they follow the same process to upload the file. The Invention copies the file off the FTP Server and places it in a specific directory, renames it and records it in the database. The Invention then archives the FTP Video for as long as the client has requested, for example, two weeks. When more than one actor appears in one Audition Video, the Casting Director can upload the video to the FTP Server, then during the Upload by FTP, they select the video and the Actors that appeared. The Invention will associate the video with each Actor. Because of the divergence in media technology and operating systems, the Casting Director using the Upload by FTP process can select videos that have been encoded in different formats (Windows Media (WMV), QuickTime (MOV)) and associate the same audition, in different formats to one Actor. Finally, the Casting Director can ePitch a Session and invite others to View the material for a brief time. Using the ePitch Invention, the Casting Director can select the Session, the Videos to be sent, select recipients, and create custom cover letters for each recipient.

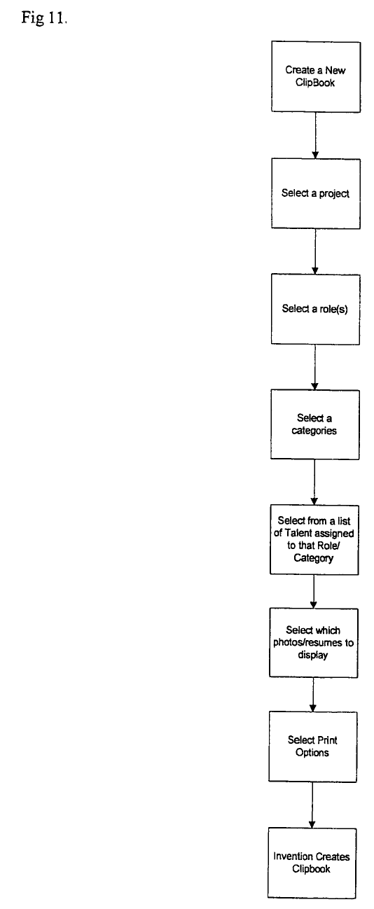

With reference to FIG. 11, the Casting Director can create a ClipBook, which the Casting Director can present to the Project Director. The Casting Director selects the ClipBook feature. The invention provides the Casting Director with a ClipBook List, a listing of previously saved ClipBooks with options to Modify, Print or Delete a ClipBook and an option to create a new ClipBook.
1. Create anew ClipBook
   a. The Casting Director selects a Project from the list of non-archived Projects.
   b. The list of Roles for the selected Project is presented to the Casting Director, from which one or more Roles are selected.
   c. Next the available Categories of actors are presented for each role. The Casting Director can select which Categories to use.
   d. The Invention then gives the Casting Director a list of the Actors who belong to the selected Categories. The Casting Director then selects which Actors are to be included in the ClipBook, and then the which materials to include in the ClipBook from these options,
      i. Do not include picture
      ii. Select a picture to include
      iii. Select whether to include the resume
   e. The Casting Director selects which print options are desired including,
      i. whether to print a cover page for each role,
         1. A Cover Page will display the Project Name, Role Name and alphabetical list of Actors selected for the role. Categories are not displayed on the Cover Page
      ii. any information to be displayed on the headers and footers of each headshot page, and each resume page,
      iii. and finally can name the schedule so it will be saved.
   f. Once the Casting Director has made their selections and pressed the “Finish” button, the invention displays the first role for printing.
      i. The Cover Page for the first role is presented first (if it was selected for printing by the Studio user) followed by the headshots and resumes for each selected actor, sorted in alphabetical order.
      ii. The page contains print break indicators so the Casting Director printer will make appropriate page breaks.
      iii. Once the first Role has been sent to the printer, the Casting Director can click “Next Role” and the print job for the next role will be presented for printing, until all roles have been displayed.
2. Modify a ClipBook
   a. If the Casting Director selects to Modify a ClipBook, then the Invention moves the Casting Director to the Select Role step of the ClipBook creation process.
   b. The previously selected Roles are indicated and the user can change them, or can click Next to leave them unchanged.
   c. The Casting Director then moves through each following step and can change or accept the saved selections.
   d. At the end, the first role is presented for printing.
3. Print a ClipBook
   a. When the Casting Director selects to Print a ClipBook, the ClipBook is prepared and presented to the user for printing by automatically opening a print dialogue box from the User's browser.
4. Delete a ClipBook
   a. If the Casting Director selects to Delete a ClipBook, and confirmation step is presented for the Casting Director to click a button to confirm the deletion.
   b. If the Casting Director confirmed the deletion, then the selected ClipBook is deleted and the Casting Director is returned to the ClipBook list page.
   c. f the Casting Director declined the deletion, then the selected ClipBook is not deleted and the Casting Director is returned to the ClipBook list page.

The present invention therefore provides a method for a user to create a relational database of Projects, add Talent to a database, create a contact database of other Users, upload Elements and relate them to Talent and/or Projects and/or Users, track Project, Talent and User related dates on a calendar, attach Talent and their selected Elements, either from an electronic Roster or a database of Talent, capture Production information through workflow into a Portal and Database that can be used for marketing, decision making and tracking, electronically request and submit the Attached Talent. The user can track materials used in the submission (e.g. Spec Script, Demo Video), ePitch selected Elements of an attached Talent or Project, create an ePackage of selected Elements of an attached Talent or Project, create various reports on Projects, create various reports on Talent, create various reports on Users, ePitch the reports, save reports to PDF, XML or Excel Spreadsheet, access through an RSS Feed. (XML), or create various reports from the Contact Management System, based on Projects. The user can secure Projects for private use, share Projects with a select group of Users, share Projects with a public group of Users, save searches for future use, create Projects that are currently being cast by a Studio, create Categories and assign them to the roles, or add Talent to a role and category. The user can manage the categories in a worksheet like presentation, with three views: Artist View, Category View and a Call Sheet view. The user can track the Calendar Availability of Talent and report by Talent or Project. The user can manage Project personnel and their contact information, upload audition material for Talent seen by an Outside Casting Director or Agent, manage the uploaded material by the Outside Casting Director or Agent or by the Casting Director. The Casting Director can move a copy of the material to the Talent's Library. A ClipBook of Talent considered for a role can be created to be used as a report or printing. The Clip is created using materials from the Talent's library.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of using the Internet to permit a plurality of users each having a computer with a web browser to create, track, cast and report on any one of a plurality of entertainment projects each having a unique title, the method comprising:
i) providing a web site maintained by a server accessible over the Internet to said plurality of users and communicating with a relational database searchable and retrievable by a search engine;
ii) a first user accessing said web site and creating a first project file for a first one of said entertainment projects by associating a unique identifier with said unique title;
iii) said user assigning a security level to said first project file wherein said security level is selected from the group consisting of private, shareable or public;
iv) said first user and others of said plurality of users periodically uploading data for storage on said database in association with said first project file depending on said selected level of security;
v) repeating steps i) through iv) to thereby produce by additional creating users a plurality of project files each having data associated therewith; and
vi) said first user, said additional creating users and/or others of said plurality of users accessing said web site and searching and retrieving certain of said data stored in said database in association with said plurality of project files depending on said selected level of security.

2. The method of claim 1 wherein said security level is selected from the group consisting of private, shareable or public.

3. The method of claim 1 wherein said plurality of users are selected from the group consisting of agents, writers, actors and other talent, casting directors, producers, production companies, distribution companies, networks and studios.

4. The method of claim 1 wherein said data comprises audio, video, photographs, scripts, documents, dates or information associated with said entertainment project.

5. The method of claim 1 wherein said entertainment project is selected from the group consisting of film, television and video.

6. The method of claim 1 wherein said data is categorized and is searchable by said category.

7. The method of claim 6 wherein said categories comprise Producer, Director, Talent and Writer.

8. The method of claim 6 wherein one of said plurality of users creates a physical report compiling portions of said data.

9. The method of claim 8 wherein said physical report is created by selecting one of said projects, selecting at least one category of data to produce a compilation of data in association with said project and printing said compilation.

10. A computer program product for using the Internet to permit a plurality of users, each having a computer with a web browser which can access a web site maintained by a server accessible over the Internet and communicating with a relational database searchable and retrievable by a search engine, to create, track, cast and report on any one of a plurality of entertainment projects each having a unique title, said method comprising:
a computer usable medium having computer readable program code means embodied in said medium for:
i) permitting a first user accessing said web site to create a first project file for a first one of said entertainment projects by associating a unique identifier with said unique title;
ii) said user assigning a security level to said first project file wherein said security level is selected from the group consisting of private, shareable or public;
iii) said first user and others of said plurality of users periodically uploading data for storage on said database in association with said first project file depending on said selected level of security;
iv) repeating steps i) through iii) to thereby produce by additional creating users a plurality of project files each having data associated therewith; and
v) said first user, said additional creating users and/or others of said plurality of users accessing said web site and searching and retrieving certain of said data stored in said database in association with said plurality of project files depending on said selected level of security.

11. The computer program product of claim 10 wherein said security level is selected from the group consisting of private, shareable or public.

12. The computer program product of claim 10 wherein said plurality of users are selected from the group consisting of agents, writers, actors and other talent, casting directors, producers, production companies, distribution companies, networks and studios.

13. The computer program product of claim 10 wherein said data comprises audio, video, photographs, scripts, documents, dates or information associated with said entertainment project.

14. The computer program product of claim 10 wherein said entertainment project is selected from the group consisting of film, television and video.

15. The computer program product of claim 10 wherein said data is categorized and is searchable by said category.

16. The computer program product of claim 15 wherein said categories comprise Producer, Director, Talent and Writer.

17. The computer program product of claim 15 wherein one of said plurality of users creates a physical report compiling portions of said data.

18. The computer program product of claim 15 wherein said physical report is created by selecting one of said projects, selecting at least one category of data to produce a compilation of data in association with said project and printing said compilation.
